(19) United States
(12) Patent Application Publication
(10) Pub. No.: US 2025/0321129 A1
(43) Pub. Date: Oct. 16, 2025

(54) METHOD AND SYSTEM FOR MEASURING PIPE FLOW RATE BY USING A SINGLE ACOUSTIC SENSOR

(71) Applicant: Yanqin LI, Zhengzhou City (CN)

(72) Inventor: Yanqin LI, Zhengzhou City (CN)

(21) Appl. No.: 18/663,117

(22) Filed: May 14, 2024

(30) Foreign Application Priority Data
Apr. 12, 2024 (CN) 2024104446706

(51) Int. Cl. G01F 1/66

(52) U.S. Cl. CPC G01F 1/66

(57) ABSTRACT

The invention concerns a method and system for gauging pipe flow rate using a lone acoustic sensor, falling within fluid measurement. It involves fixing an acoustic sensor to the pipe wall and employing a computer with pre-installed measurement software. Digital-to-analog and analog-to-digital conversion cards interface between the sensor and software, with the computer controlling the sensor via the software. By siting a single acoustic sensor at the pipe's cross-section, the method measures and computes the average axial flow velocity along the corresponding diameter line. This, combined with the cross-sectional area, yields the flow rate. With just one acoustic sensor, the system is significantly simplified, ensuring reliability with minimal systematic error and high precision. Compared to traditional methods, the invention reduces the demands on pipe conditions for accurate measurement.

### TECHNICAL FIELD

The invention relates to the field of fluid measurement technology, in particular to a method and system for measuring pipe flow rate by using a single acoustic sensor.

### BACKGROUND ART

The flow rate in a pipe or container is an important or key technical parameter for a large number of industrial and scientific applications, which requires effective measurement methods. Acoustic wave method is an applicable and advanced measurement method. In most cases, the axial flow velocity does not change significantly along the cross-section of the pipe, so the average axial flow velocity along any diameter line can approximately represent the average flow velocity across the whole cross-section. Sometimes the particularity of the medium properties in the horizontal pipe will cause the flow velocity within the cross-section to change along the vertical direction. At this time, the average flow velocity along the vertical diameter is generally closer to the average flow velocity of the cross-section, sometimes, due to the change of spatial arrangement such as pipe turning, the corresponding flow velocity may change along the horizontal direction or the vertical direction, at this time, the average flow velocity along the horizontal direction diameter or the vertical direction diameter is closer to the average flow velocity across the cross-section.

At present, there is an ultrasonic flowmeter based on time difference method for pipe flow rate measurement, a pair of acoustic sensors are arranged along the upstream and downstream of the pipe to be measured, by measuring the propagation time of the two acoustic sensors in the two mutual directions, the pipe flow rate can be effectively measured, but the system is relatively complex.

In addition, the existing technology can refer to the patent with an application number of CN201880010719.X (the same PCT patent application number: U.S. Pat. No. 10,739,174 B2, Japan 7032842, Europe EP18930151.8), its name is the method and system for measuring the axial flow velocity distribution and flow rate in the pipe by using acoustic wave method, which relates to a method and system for measuring a pipe flow rate reliably obtained by arranging a certain number of acoustic sensors along the perisphere of a single cross-section of the pipe to be measured and calculating the axial flow velocity distribution across the cross-section through a reconstruction algorithm. However, as mentioned above, in practical industrial applications, it is not necessary to know the axial flow velocity distribution across the cross-section of the pipe in most cases. Nevertheless, as mentioned above, in general, the axial flow velocity of the pipe does not change significantly across the cross-section, or even if there is a significant change, the average flow velocity along the diameter line is close enough to the average flow velocity across the whole cross-section, which can effectively replace the latter, and further calculate the flow rate to be measured. Moreover, the method disclosed by the existing technology does not involve the problem of single path flow rate measurement, nor does it involve the method of using a single acoustic sensor to measure flow rate.

The traditional time difference method requires two acoustic sensors to transmit acoustic waves mutually and receive acoustic signals respectively. In the above-mentioned acoustic wave method of axial flow velocity distribution measurement with a single cross-section, each acoustic path also requires an acoustic wave sensor to transmit acoustic waves, and an acoustic wave sensor at the other end to receive acoustic signals.

### SUMMARY OF THE INVENTION

The purpose of the invention is to provide a method and system for measuring pipe flow rate by using a single acoustic sensor to solve problems mentioned in the background technology.

In order to achieve the above purpose, the invention provides a system for measuring pipe flow rate by using a single acoustic sensor, comprising an acoustic sensor fixed to the wall of the pipe to be measured and a computer with a measurement software preset inside, a digital-to-analog conversion card and an analog-to-digital conversion card are arranged between the acoustic wave sensor and the measurement software, the acoustic sensor is controlled by the computer to send and receive acoustic signals through the measurement software, and the round-trip propagation time of the acoustic wave transmitted by the acoustic sensor along the cross-section of the pipe to be tested and received by the same acoustic sensor after returning through the opposite side wall is calculated, the average axial flow velocity along the acoustic propagation diameter line can be calculated subsequently, which is approximated as the average axial flow velocity across the whole cross-section, and the flow rate of the pipe to be measured can be further obtained.

Preferably, the front surface of the acoustic sensor is tangent to the wall of the pipe to be measured, and the vertical central axis of the front surface vertically intersects the central axis of the pipe to be measured.

A method for measuring pipe flow rate by using a single acoustic sensor is as follows:
S1, selecting a cross-section in the stable section or target section of the pipe to be tested, and fixing a single acoustic sensor to the wall of the pipe to be tested, making sure that the front surface of the acoustic sensor tangent to the wall of the pipe to be tested, and intersecting the acoustic propagation path with the axis of the pipe to be tested at the cross-section in the pipe.
S2, measuring the time of the acoustic wave transmitted by the acoustic sensor reaching the pipe wall on the opposite side of the acoustic sensor and finally returning to the acoustic sensor, combining with the distance that the acoustic wave travels from the front surface of the acoustic sensor to the pipe wall on the opposite side of the flow medium and the velocity of acoustic wave propagation in the medium to be measured, calculating the average axial flow velocity along the acoustic propagation path, and further calculating the flow rate of the pipe to be tested in combination with the area of the cross-section to be tested.

Preferably, the propagation time of the acoustic wave transmitted by the acoustic sensor reaching the opposite wall of the pipe and returning to the acoustic sensor is taken, which is substituted into the following reconstruction equation to calculate the average flow velocity ū along the cross-section acoustic propagation diameter of the pipe to be measured:

$$\overline{u} = \cdot \sqrt{{c}^{2} - {( \frac{L}{Δ t / 2} )}^{2}}$$

Wherein L is the propagation distance of the acoustic wave along the bending path that intersects the central axis of the pipe to be measured and reaches the pipe wall on the opposite side; Δt is the total propagation time of the acoustic wave transmitting from the acoustic sensor through the pipe wall on the opposite side and reflecting back to the acoustic sensor, and c is the acoustic wave propagation velocity of the medium to be measured in the pipe under static conditions.

Preferably, according to the average flow velocity u along the acoustic propagation diameter of the cross-section, which is approximated as the average flow velocity across the cross-section, it is multiplied by the cross-section area to obtain the flow rate in the pipe to be measured.

Therefore, the invention adopts the above one kind of single acoustic wave sensor to measure the pipe flow rate, the method and system have the following beneficial effects:

(1) Only a single acoustic sensor is arranged to the wall of the pipe to be measured, and the total propagation time of the acoustic wave transmitted from the acoustic sensor and reaching the opposite side wall and finally returning to the sensor is measured, then the average flow velocity along the diameter line of the measured pipe cross-section can be effectively calculated, which is approximated as the average flow velocity of the whole cross-section, and the flow rate in the pipe can be calculated. Compared with the existing methods, it is essentially simplified and convenient, only a single acoustic sensor is needed to transmit and receive acoustic signals, which reduces the systematic error of the measurement and is beneficial to obtain more reliable measurement results.

(2) The system is greatly simplified, and has the characteristics of small error, high precision and reliability; compared with the traditional time difference method, the requirements of the measurement of the invention on the pipe conditions are also greatly reduced.

The following is a further detailed description of the technical scheme of the invention through drawings and embodiments.

### BRIEF DESCRIPTION OF DRAWINGS

FIG. 1 is a layout diagram of the acoustic sensor configuration of the invention;

FIG. 2 is a schematic diagram of the pipe to be tested and the arrangement of single acoustic sensor at five different positions of the embodiment of the invention;

FIG. 3 is a schematic diagram of the measured acoustic wave round-trip sound path distribution for the symmetrical distribution of the flow velocity of the embodiment of the invention; and

FIG. 4 is the round-trip sound path distribution for the deflection flow velocity distribution of the embodiment of the invention.

### TAGS OF DIAGRAM

1, the pipe to be tested; 2. the acoustic sensor; 3, the sound path.

### DETAILED DESCRIPTION OF THE EMBODIMENTS

### Embodiment

The following will be combined with the drawings of the embodiment of the invention to clearly and completely describe the technical scheme of the embodiment of the invention. Obviously, the described embodiment is only a part of the embodiments of the invention, not all the embodiments. Based on the embodiments in the invention, all other embodiments obtained by ordinary technicians in the field without making creative labor are within the protection scope of the invention.

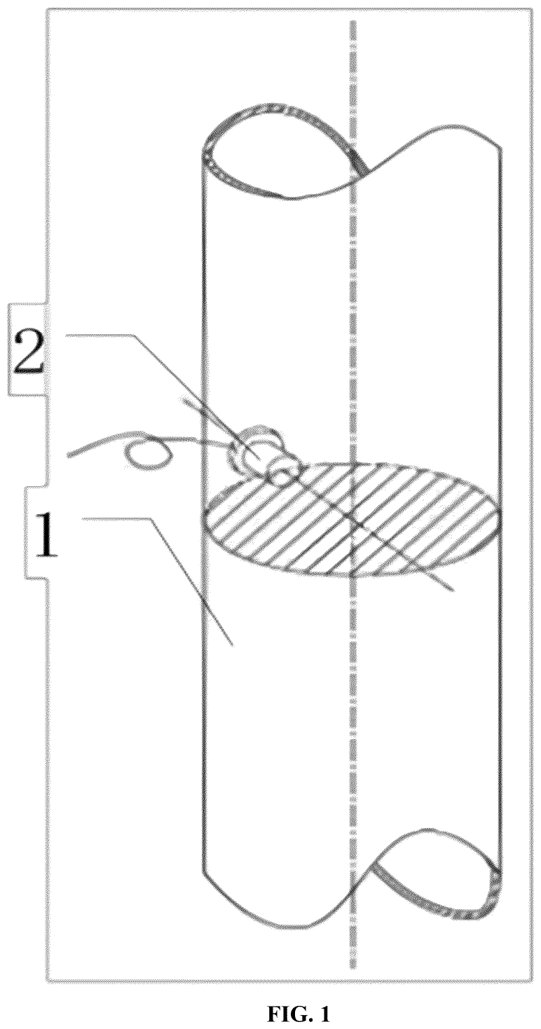

Refer to FIG. 1, the invention provides a system for measuring pipe flow rate by using a single acoustic sensor, comprising an acoustic sensor 2 fixed to the wall of the pipe to be measured 1 and a computer with a measurement software preset inside. A digital-to-analog conversion card and an analog-to-digital conversion card are arranged between the acoustic wave sensor 2 and the measurement software, the acoustic sensor 2 is controlled by the computer to send and receive acoustic signals through the measurement software. And the round-trip propagation time of the acoustic wave transmitted by the acoustic sensor 2 along the cross-section of the pipe to be tested 1 and received by the same acoustic sensor 2 after returning through the opposite side wall is calculated, the average axial flow velocity along the acoustic propagation diameter line can be calculated, which is approximated as the average axial flow velocity across the whole cross-section, and the flow rate of the pipe to be measured can be further obtained, there are calculation and measurement methods in the measurement software.

The digital-to-analog conversion card is used to convert the audio digital signal issued by the computer's measurement software into acoustic wave analog signal, which is transmitted by the acoustic sensor 2.

The analog-to-digital conversion card is respectively connected with the measuring computer and the acoustic sensor 2, and it is used to convert the measured acoustic wave information in the pipe collected by the acoustic sensor 2 into a digital signal and then input it into the measuring computer.

The front surface of the acoustic sensor is tangent to the wall of the pipe to be measured, and the vertical central axis of the front surface vertically intersects the central axis of the pipe to be measured.

If the fluid in the pipe 1 to be tested is gas, or two-phase flow or multi-phase flow dominated by gas, a hole must be drilled through the wall of the pipe to be tested 1, the acoustic sensor 2 is installed in the hole, and the front surface of the acoustic sensor 2 is flush with the inner surface of the pipe to be tested 1.

If the fluid in the pipe to be tested 1 is liquid or dominated by liquid, then the front surface of the acoustic sensor 2 can be directly fixed on the outer surface of the pipeline to be measured 1 for measuring without drilling.

A method for measuring pipe flow rate by using a single acoustic sensor is as follows:

S1, selecting a cross-section in the stable section or target section of the pipe to be tested 1, and fixing a single acoustic sensor 2 to the wall of the pipe to be tested 1, making sure that the front surface of the acoustic sensor 2 tangent to the wall of the pipe to be tested 1, and intersecting the acoustic propagation path with the axis of the pipe to be tested 1 at the cross-section in the pipe.

S2, measuring the time of the acoustic wave transmitted by the acoustic sensor and reaching the pipe wall on the opposite side of the acoustic sensor and finally returning to the acoustic sensor, combining with the distance that the acoustic wave travels from the front surface of the acoustic sensor to the pipe wall on the opposite side of the flow medium and the velocity of acoustic wave propagation in the medium to be measured, calculating the average axial flow velocity along the acoustic propagation path, and further calculating the flow rate in the pipe to be tested.

Preferably, the propagation time of the acoustic wave transmitted by the acoustic sensor reaching the opposite wall of the pipe and returning to the acoustic sensor is taken, which is substituted into the following reconstruction equation to calculate the average flow velocity ū along the cross-section acoustic propagation diameter of the pipe to be measured:

$$\overline{u} = \cdot \sqrt{{c}^{2} - {( \frac{L}{Δ t / 2} )}^{2}}$$

Wherein L is the propagation distance of the acoustic wave along the bending path that intersects the central axis of the pipe to be measured and reaches the pipe wall on the opposite side; Δt is the total propagation time of the acoustic wave transmitting from the acoustic sensor through the pipe wall on the opposite side and reflecting back to the acoustic sensor, and c is the acoustic wave propagation velocity of the medium to be measured in the pipe under static conditions.

According to the average velocity u along the acoustic propagation diameter of the cross-section, which is approximated as the average flow velocity across the cross-section, it is multiplied by the cross-section area to obtain the flow rate in the pipe to be measured.

Since the measurement methods involved in this embodiment are applicable to pipes or containers with different cross-sections, typically circular, elliptical or rectangular, the axial flow velocity distribution of a circular cross-section pipe is taken as an example to verify the acoustic wave method proposed in this embodiment.

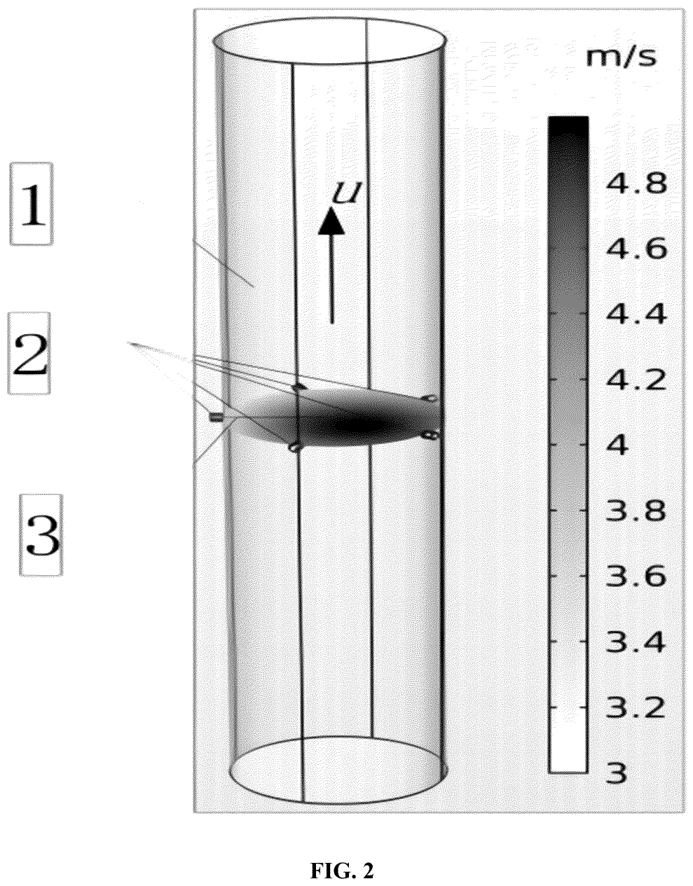

As shown in FIG. 2, a cross-section of the steady flow section in the circular cross-sectional pipe is selected, and a single acoustic sensor 2 is arranged at five different positions on the wall around the cross-section, one of which shows the distribution of the sound path 3 of the transmitted acoustic wave. Based on the method proposed in this embodiment, the average flow velocity along the corresponding diameter line is measured and calculated, and it is compared with its actual average flow velocity and the actual average value across the whole cross-section. The diameter of the pipe is 1 m, the medium is air, and the temperature is room temperature, the coordinate system is set up with the geometric center of the cross-section of the pipe as the origin. The preset simulation field of the axial flow field in the cross-section pipe with the flow field center located at the cross-section geometric center and inclined from the geometric center are constructed, respectively.

The work conditions 1 and 2 of simulation flow field are defined, respectively, in Table 1.

TABLE 1
The parameters of the simulation axial flow
field across the cross-section of the pipe.

| Work | The construction of flow field |
|---|---|
| condition | based on the analytical function. |
| 1 | u(x, y) = 5e^{-(x}^{²}^{+y}^{²}⁾(m/s) |
| 2 | u(x, y) = 5e^{-0.5((x-0.1)}^{²}⁺^{(y+0.15)}^{²}⁾(m/s) |

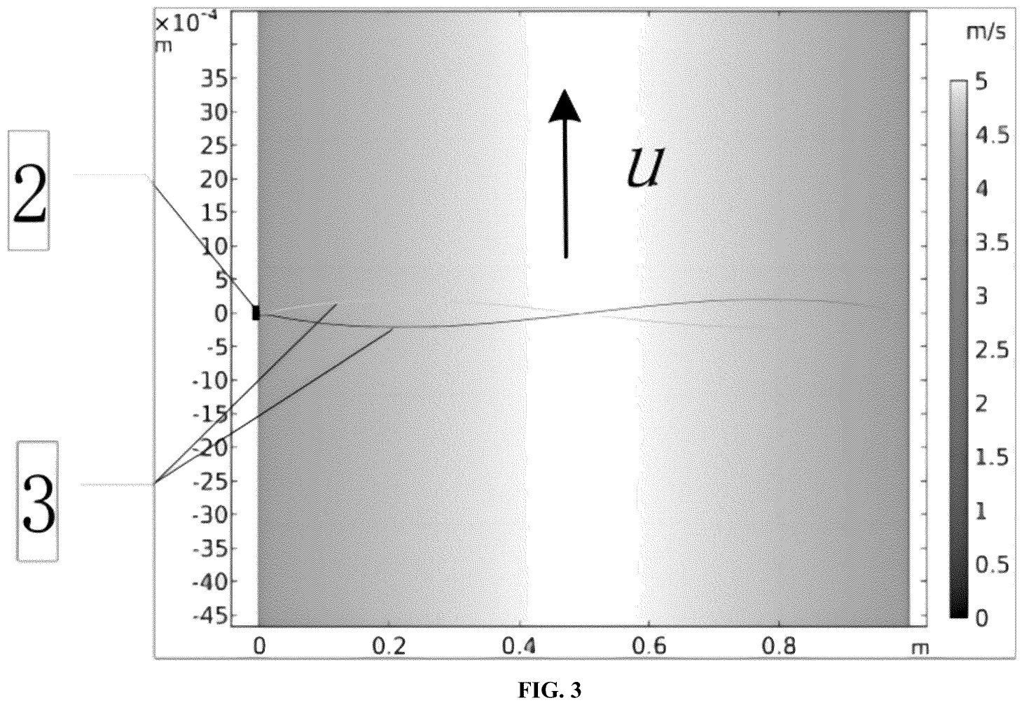

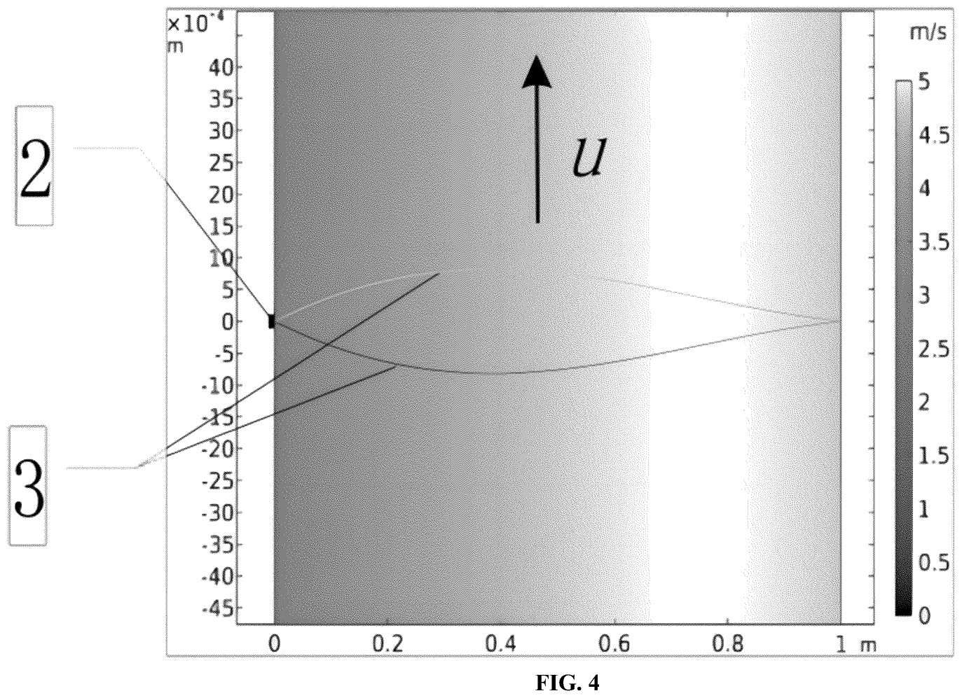

Through the path integral, the round-trip propagation time of the acoustic wave by the single acoustic sensor 2 arranged at different positions determined by work conditions 1 and 2 is obtained, as shown in Table 2 and Table 3 respectively. The distribution of sound path 3 in the two working conditions is shown in FIG. 3 and FIG. 4. In order to clearly display, both FIG. 3 and FIG. 4 are elongated by 100 times along the axial direction.

TABLE 2
Working condition 1 Propagation time (unit: s) and corresponding average
flow velocity (unit: m/s) along each path in the simulation flow field.

| Acoustic path | AA | BB | CC | DD | EE |
|---|---|---|---|---|---|
| Δt | 0.005827973 | 0.005827973 | 0.005827973 | 0.005827973 | 0.005827973 |
| Reconstructed | 4.6136 | 4.6136 | 4.6136 | 4.6136 | 4.6136 |
| ū | | | | | |
| Actual | 4.6128 | 4.6128 | 4.6128 | 4.6128 | 4.6128 |
| ū | | | | | |
| The actual average flow velocity across | 4.4241 | | | | |
| the cross-section to be measured | | | | | |

TABLE 3
Work condition 2 Propagation time (unit: s) and corresponding average
flow velocity (unit: m/s) of each path in the simulation flow field.

| Acoustic path | AA | BB | CC | DD | EE |
|---|---|---|---|---|---|
| Δt | 0.0058279985 | 0.0058279986 | 0.0058279993 | 0.0058279980 | 0.0058279994 |
| Reconstructed | 4.7257 | 4.7261 | 4.7291 | 4.7236 | 4.7296 |
| ū | | | | | |
| Actual | 4.7238 | 4.7243 | 4.7273 | 4.7219 | 4.7276 |
| ū | | | | | |
| The actual average flow velocity across | 4.6290 | | | | |
| the cross-section to be measured | | | | | |

It can be seen that the average flow velocity can be measured satisfactorily for the two typical flow conditions of symmetrical distribution and skewed distribution, and then the flow rate is obtained by multiplying the cross-sectional area by the approximate value of the average flow velocity across the measured cross-section. Among them, the difference between the average flow velocity along the diameter line reconstructed by the method disclosed in this embodiment and the actual value is small enough, and the error to approximate the average flow velocity across the cross-section is not obvious. It should be noted that the traditional method based on the time difference method by using a pair of acoustic sensors to measure the flow rate is also to reconstruct the average flow velocity along the corresponding diameter line.

The non-uniformity of the flow velocity in the two experimental pipes is obvious, while the change of the flow velocity across the cross-section in the actual pipe is relatively weak in general, and the reliability of the measurement results will be higher. In short, the numerical experiment shows that the pipe flow rate measurement results published in this embodiment are accurate and reliable enough.

The method disclosed in this embodiment can be applied to the effective measurement of axial average flow velocity and flow rate in gas, liquid, and two-phase or multi-phase flow pipes, it can also be extended to the measurement of internal flow fields such as combustion chambers, fluidized beds, chemical reactors, and open jets.

The system of this embodiment can be made into a hand-held or portable system after corresponding improvement.

It should be noted that in the measurement, the acoustic frequency can be reasonably selected according to the size of the measured object and the properties of the fluid medium.

For gas or related multi-phase media, the attenuation rate of acoustic wave is proportional to the square of the acoustic frequency, so the higher the frequency, the greater the attenuation; however, the larger the acoustic wave frequency is, the more conducive it is to obtain high-precision acoustic wave propagation time data, and then to obtain high-precision measurement results. Therefore, on the basis of satisfying the returned acoustic wave signal with sufficient magnitude, the acoustic frequency can be adopted as high as possible to ensure sufficient measurement accuracy.

In addition, the cross-section shape of the measured object, the appropriate deformation of the axial average velocity field calculation formula, and the position of the acoustic propagation path in the measured section will not affect the effect of the embodiment.

Therefore, the invention adopts the method and system of measuring pipe flow rate by using a single acoustic sensor, where the acoustic sensor only needs one, which is half of the traditional ultrasonic flowmeter based on the time difference method, the system is greatly simplified in comparison, the system error is relatively small, and the measurement results are reliable, at the same time, the requirements for the measured pipe condition are greatly reduced.

Finally, it should be noted that the above embodiment is only used to explain the technical scheme of the invention and not to restrict it, although the invention is described in detail with reference to the better embodiment, the ordinary technical technicians in this field should understand that they can still modify or replace the technical scheme of the invention, and these modifications or equivalent substitutions cannot make the modified technical scheme out of the spirit and scope of the technical scheme of the invention.

What is claimed is:

1. A method and system for measuring pipe flow rate by using a single acoustic sensor, comprising an acoustic sensor fixed to a wall of a pipe to be measured and a computer with a measurement software preset inside, a digital-to-analog conversion card and an analog-to-digital conversion card are arranged between the acoustic sensor and the measurement software, the acoustic sensor is controlled by the computer to send and receive acoustic signals through the measurement software, and a time of a round-trip propagation of an acoustic wave pulse transmitted by the acoustic sensor across a cross-section of the pipe to be tested and received by the same acoustic sensor after returning through an opposite side wall is calculated, an average axial flow velocity along an acoustic propagation diameter line can be calculated, which is approximated as the average axial flow velocity across the whole cross-section, and a flow rate in the pipe to be measured can be further obtained.

2. The system for measuring pipe flow rate by using a single acoustic sensor according to claim 1, a front surface of the acoustic sensor is tangent to the wall of the pipe to be measured, and a vertical central axis of the front surface vertically intersects a central axis of the pipe to be measured.

3. A method for measuring pipe flow rate by using a single acoustic sensor, comprising the following steps:
S1, selecting a cross-section in a stable section or a target section of a pipe to be tested, and fixing the single acoustic sensor to a wall of the pipe to be tested, making sure that a front surface of the acoustic sensor tangent to the wall of the pipe to be tested, and intersecting an acoustic propagation path with an axis of the pipe to be tested at the cross-section in the pipe;
S2, measuring a propagation time of an acoustic wave from transmitted by the acoustic sensor, then reaching a pipe wall on an opposite side of the acoustic sensor, to finally returning to the acoustic sensor, combining with a distance that the acoustic wave travels from the front surface of the acoustic sensor to the pipe wall on the opposite side of the flow medium and a velocity of an acoustic wave propagation in the medium to be measured, calculating an average axial flow velocity along the acoustic propagation path, and further calculating a flow rate of the pipe to be tested in combination with a cross-section area to be tested.

4. The method for measuring pipe flow rate by using a single acoustic sensor according to claim 3, a propagation time of the acoustic wave transmitted by the acoustic sensor reaching the pipe wall on the opposite side and returning to the acoustic sensor is taken, which is substituted into a following reconstruction equation to calculate an average flow velocity ū along a cross-section acoustic propagation diameter across the cross-section of the pipe to be measured:
$$\overline{u} = \cdot \sqrt{{c}^{2} - {( \frac{L}{Δ t / 2} )}^{2}}$$
wherein L is a propagation distance of the acoustic wave along a bending path that intersects a central axis of the pipe to be measured and reaches the pipe wall on the opposite side; Δt is the total propagation time of the acoustic wave transmitting from the acoustic sensor through the pipe wall on the opposite side and reflecting back to the acoustic sensor, and c is an acoustic wave propagation velocity of a medium to be measured in the pipe under static conditions.

5. The method for measuring pipe flow rate by using a single acoustic sensor according to claim 4, according to the average flow velocity ū along a cross-sectional acoustic propagation diameter, which is approximated as the average flow velocity across the cross-section, it is multiplied by a cross-section area to obtain a flow rate in the pipe to be measured.
